(19) United States
(12) Patent Application Publication
(10) Pub. No.: US 2010/0196246 A1
(43) Pub. Date: Aug. 5, 2010

(54) METHODS FOR MITIGATING AGGLOMERATION OF CARBON NANOSPHERES USING A CRYSTALLIZING DISPERSANT

(75) Inventors: Cheng Zhang, Pennington, NJ (US); Bing Zhou, Cranbury, NJ (US)

Correspondence Address: Workman Nydegger;1000 Eagle Gate Tower, 60 East South Temple, Salt Lake City, UT, 84111, US

(73) Assignee: HEADWATERS TECHNOLOGY INNOVATION, LLC, Lawrenceville, NJ (US)

(21) Appl. No.: 12/757,813

(22) Filed: Apr. 9, 2010

Related U.S. Application Data
(63) Continuation-in-part of application No. 11/869,519, filed on Oct. 9, 2007.
Application No. 11/869,519 is a continuation-in-part of application No. 11/869,545, filed on Oct. 9, 2007.

(51) Int. Cl. C01B 31/02

(52) U.S. Cl. 423/445 R; 977/773; 977/734

(57) ABSTRACT

Novel methods for manufacturing carbon nanostructures (e.g., carbon nanospheres) that are highly dispersed include forming a precursor composition, polymerizing the precursor composition, and carbonizing the polymerized material (e.g., through pyrolysis) to form the carbon nanostructures. The precursor composition includes catalytic metals and a crystallizing dispersant. The crystallizing dispersant forms a crystalline phase in the polymerized precursor material which facilitates the formation of dispersed carbon nanostructures during the carbonation step.

### CROSS REFERENCE TO RELATED APPLICATIONS

This application is a continuation in part of U.S. patent application Ser. No. 11/869,519, entitled “Functionalization of Carbon Nanospheres By severe Oxidative Treatment”, Filed Oct. 9, 2007 and U.S. patent application Ser. No. 11/869,545, entitled “Highly Dispersible Carbon Nanospheres In An Organic Solvent And Methods For Making Same”, Filed Oct. 9, 2007, the disclosures of which are hereby incorporated herein by reference in their entirety.

### BACKGROUND OF THE INVENTION

1. The Field of the Invention

The present invention relates generally to the manufacture of carbon nanomaterials. More particularly, the present invention relates to methods for manufacturing highly dispersed carbon nanospheres using a crystallizing dispersant.

2. The Related Technology

Carbon materials have been used in a variety of fields as high-performance and functional materials. Pyrolysis of organic compounds is known to be a useful method for preparing carbon materials. For example, carbon materials can be produced by pyrolyzing resorcinol-formaldehyde gel at temperatures above 600° C.

Most carbon materials obtained by pyrolysis of organic compounds at temperatures between 600-1400° C. tend to be amorphous or have a disordered structure. Obtaining highly crystalline or graphitic carbon materials can be very advantageous because of the unique properties exhibited by graphite. For example, graphitic materials can be conductive and form unique nanomaterials such as carbon nanotubes. However, using existing methods it is difficult to make these well-crystallized graphite structures using pyrolysis, especially at temperatures less than 2000° C.

To acquire the graphitic structure at lower temperature many studies have been carried out on carbonization in the presence of a metal catalyst. The catalyst is typically a salt of iron, nickel, or cobalt that is mixed with carbon precursor. Using catalytic graphitization, graphitic materials can be manufactured at temperatures between 600° C. and 1400° C.

Recently, this method has been used to manufacture carbon nanotubes and other carbon nanostructures. The carbon nanostructures are manufactured by mixing a carbon precursor with iron nanoparticles and carbonizing the precursor to cause the carbon nanostructure to grow from or around the iron nanoparticles. The iron nanoparticles are removed from the material by treating with strong acids. The amorphous carbon is typically removed using an oxidizing agent such as potassium permanganate.

### BRIEF SUMMARY OF THE INVENTION

The present invention relates to novel methods for manufacturing carbon nanostructures (e.g., carbon nanospheres) that are highly dispersed and have minimal agglomeration of particles. The method includes forming a precursor composition, polymerizing the precursor composition, and carbonizing the polymerized material (e.g., through pyrolysis) to form the carbon nanostructures. The precursor composition includes catalytic metals and a crystallizing dispersant. The crystallizing dispersant forms a crystalline phase in the polymerized precursor material which facilitates the formation of dispersed carbon nanostructures during the carbonation step.

In one embodiment, a method for manufacturing a carbon nanomaterial may include the steps of (i) forming a precursor mixture comprising a carbon precursor, a catalytic metal, and a crystallizing dispersant (ii) polymerizing the carbon precursor to form a polymerized carbon material having a crystalline phase therein where the crystalline phase is derived from the crystallizing dispersant; (iii) carbonizing the polymerized carbon material to form an intermediate carbon material including a plurality of carbon nanostructures, amorphous carbon, and catalytic metal; and (iv) purifying the intermediate carbon material by removing at least a portion of an amorphous carbon and at least a portion of the catalytic metal.

The crystallizing dispersant may be a carbohydrate such as a monosaccharide. Examples of suitable monosaccharides include fructose and glucose. However, other carbohydrates and/or different monosaccharides may be used alone or in combination with fructose and/or glucose. In one embodiment, the crystallizing dispersant is included in the precursor mixture in a molar ratio in a range from about 0.25:1 to about 1:0.25 of crystalline dispersant to carbon precursor. More specifically, the molar ratio may be in a range from about 0.5:1 to about 1:0.5 of crystalline dispersant to carbon precursor.

The crystallizing dispersant may form a crystalline phase within the polymerized carbon material. During the polymerization step, carbonizing step, and/or the purifying step, the crystalline phase mitigates the formation of and/or perseverance of agglomeration between carbon nanomaterial particles.

Carbon nanomaterials manufactured using the methods of the invention tend to exhibit a less agglomerated material than carbon nanomaterials manufactured using similar techniques but with organic dispersing molecules complexed with the catalytic metals. The carbon nanomaterials can be more easily blended with solvents and other materials due to the reduced agglomeration as compared to carbon nanomaterials prepared without using a crystallizing dispersant.

These and other advantages and features of the present invention will become more fully apparent from the following description and appended claims as set forth below.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high resolution TEM image of carbon nanospheres manufactured according to the methods described herein; and

FIG. 2 is another high resolution TEM image of carbon nanospheres manufactured according to the methods described herein; and

FIGS. 3A and 3B are high resolution TEM images of carbon nanospheres manufactured without a crystallizing dispersant for comparison with the carbon nanospheres manufactured according to the present invention and illustrated in FIGS. 1 and 2.

### DETAILED DESCRIPTION OF EXAMPLE EMBODIMENTS

### I. Introduction and Definitions

The present invention is directed to methods for manufacturing carbon nanostructures (e.g., carbon nanospheres) using carbon precursors and carbonation. The formation of the carbon nanostructures is controlled in part using a crystallizing dispersant to form the precursor mixture. The crystallizing dispersant has been found to substantially reduce agglomeration in the purified carbon nanomaterials manufactured from the precursor mixture.

In one embodiment the carbon nanostructures manufactured using the methods disclosed herein may produce carbon nanospheres. The carbon nanostructures may have a plurality of carbon layers forming a wall that generally appears to define a nanosphere. In one embodiment, the carbon nanostructure can be characterized as hollow but irregularly shaped multi-walled, sphere-like (or spheroidal) nanostructures when analyzed in view of SEM images in combination with TEM images of the same material. In one embodiment, the carbon nanostructures form clusters of grape-like structures as seen in SEM images but which are known to be hollow multi-walled nanostructures as shown by TEM images of the same material. For purposes of this invention, the term nanosphere includes graphitic, hollow particles or balls that have an irregular outer shape and a hollow center surrounded by a graphitic wall.

### II. Components Used to Manufacture Carbon Nanostructures

The following components can be used to carry out the above mentioned steps for manufacturing carbon nanostructures according to the present invention.

A. Carbon Precursor

Any type of carbon material can be used as the carbon precursor of the present invention so long as it can form a solution with the catalytic metal and the crystallizing dispersant and then carbonize upon heat treating. Suitable compounds include single and multi-ring aromatic compounds such as benzene and naphthalene derivatives that have polymerizable functional groups. Also included are ring compounds that can form single and multi-ring aromatic compounds upon heating. Functional groups that can participate in polymerization include COOH, C═O, OH, C═C, SO₃, NH₂, SOH, N═C═O, and the like.

The carbon precursor can be a single type of molecule (e.g., a compound that can polymerize with itself), or the carbon precursor can be a combination of two or more different compounds that co-polymerize together. For example, in an exemplary embodiment, the carbon precursor can be a resorcinol-formaldehyde gel. In this two compound embodiment, the formaldehyde acts as a cross-linking agent between resorcinol molecules by polymerizing with the hydroxyl groups of the resorcinol molecules.

Other examples of suitable carbon precursors include resorcinol, phenol resin, melamine-formaldehyde gel, poly(furfuryl alcohol), poly(acrylonitrile), sucrose, petroleum pitch, and the like. Other polymerizable benzenes, quinones, and similar compounds can also be used as carbon precursors and are known to those skilled in the art.

In an exemplary embodiment, the carbon precursor is a hydrothermally polymerizable organic compound. Suitable organic compounds of this type include citric acid, acrylic acid, benzoic acid, acrylic ester, butadiene, styrene, cinnamic acid, and the like.

B. Catalytic Metal

Catalytic metals, preferably metal salts may be included in the carbon precursor composition. When mixed with the carbon precursor, the catalytic metal may serve as templating nanoparticles and/or nucleation site where carbonization and/or polymerization can begin or be enhanced.

The catalyst atom used to form the templating nanoparticles can be any material that can cause or promote carbonization and/or polymerization of the carbon precursor. In a preferred embodiment, the catalyst is a transition metal salt including but not limited to salts of iron, cobalt, or nickel. These transition metal catalysts are particularly useful for catalyzing many of the polymerization and/or carbonization reactions involving the carbon precursors described herein. The metal salts can be mixed into the precursor mixture as metal salts or can be provided as elemental metals that when mixed with oxidizing agents to form metal salts in-situ.

C. Crystallizing Dispersants

The crystallizing dispersant is selected for its ability to be mixed with the carbon precursor and/or solvent and to form a crystalline phase within the polymerized carbon precursor. The crystallizing dispersant may be a carbohydrate such as, but not limited to, a monosaccharide. Examples of suitable carbohydrates include allose, altrose, glucose, gulose, idose, talose, psicose, fructose, sorbose, tagatose, ribose, arabinose, xylose, lyxose, ribulose, xylulose, derivatives of these and/or combinations of these. In one embodiment, the crystallizing dispersant may be a hexose or a pentose. Glucose and/or fructose and/or their derivatives may be preferred in some embodiments.

D. Reagents for Purifying Intermediate Carbon Materials

Various reagents can be used to remove amorphous carbon and/or the catalytic metals from the carbon nanostructures, thereby purifying the intermediate material. The purification can be carried out using any reagent or combination of reagents capable of selectively removing amorphous carbon (or optionally catalytic metal) while leaving graphitic material.

Reagents for removing amorphous carbon include oxidizing acids and oxidizing agents and mixtures of these. An example of a mixture suitable for removing amorphous carbon includes sulfuric acid, KMnO₄, H₂O₂, 5M or greater HNO₃, and aqua regia.

The catalytic metal can be removed using any reagent that can selectively dissolve the particular metal used as the catalyst without significantly destroying the carbon nanostructures, which are graphitic. Nitric acid is an example of a reagent suitable for dissolving many base transition metals such as, but not limited to, iron, cobalt, and nickel. Other examples of suitable reagents include hydrogen fluoride, hydrochloric acid, and sodium hydroxide.

### III. Manufacturing Carbon Nanostructures

The carbon nanostructures of the present invention can be manufactured using all or a portion of the following steps: (i) forming a precursor mixture that includes a carbon precursor, a catalytic metal, a crystallizing dispersant, and optionally a solvent (ii) polymerizing the carbon precursor to form a polymerized carbon material and a crystalline phase therein formed from the crystallizing disperant, (iii) carbonizing the precursor mixture to form an intermediate carbon material that includes a plurality of nanostructures (e.g., carbon nanospheres), amorphous carbon, and catalytic metal, and (iv) purifying the intermediate carbon material by removing at least a portion of the amorphous carbon and optionally a portion of the catalytic metal.

A. Forming a Precursor Mixture

The precursor mixture is formed by selecting a carbon precursor, a catalytic metal, a crystallizing dispersant, and optionally solvents and/or other additives. The components of the precursor solution can be prepared as separate solutions and mixed together or they can be added all together or in any combination.

The crystallizing dispersant is selected to minimize agglomeration of the carbon nanostructures formed in subsequent steps. Examples of suitable compounds include carbohydrates such as monosaccharides including, but not limited to, glucose and fructose. In one embodiment, the dispersing agent can be selected in combination with the solvent and pH to produce a mixture of metal atoms and crystalline dispersants that can form a crystalline interlayer in the carbon precursor. In this embodiment, the crystalline dispersant may be selected in combination with the solvent and metal to avoid forming a complex with the metal atoms, thereby allowing the crystalline interlayer to form. For example, in some embodiments, it may be desirable to prepare the precursor composition with solvents and crystallizing dispersants that do not yield stable ionized crystallizing dispersants in solution.

In one embodiment, the pH of the solvent mixture may be selected to avoid ionization of the crystallizing dispersant. In one embodiment the pH of the precursor mixture may be greater than 4.0, preferably greater than 5.0, and more preferably greater than 6.0.

The crystallizing dispersant is included in the precursor mixture in a molar ratio sufficient to inhibit agglomeration of carbon nanostructures formed in the methods described herein. In one embodiment, the molar ratio of crystalline dispersant to carbon precursor may be in a range from about 0.25:1 to about 1:0.25; preferably, 0.5:1 to about 1:0.5.

In one embodiment, the catalytic metals can be formed into catalytic templating nanoparticles, which may be dispersed in the carbon precursor or formed in-situ in the carbon precursor or the polymerized carbon material. In one embodiment, the templating nanoparticles are formed in the carbon precursor from a metal salt. In this embodiment, the templating nanoparticles may be formed by selecting one or more catalyst metal salts that can be mixed with the carbon precursor. The metal salts are mixed with the carbon precursor and then allowed or caused to form nanoparticles in-situ.

If desired templating particles may be formed (in-situ or ex-situ) using an organic complexing agent. The organic complexing agents may facilitate controlling particle formation and therefore catalytic activity. Example of suitable organic complexing agents include compounds having carboxylic acid groups that can complex with the metal atoms (e.g., glycolic acid, citric acid, glycine, and polyacrylic acid). However, the complexing agent is typically selected to minimize its affects on the crystallizing dispersant and is not necessarily included.

B. Polymerizing the Precursor Mixture

Polymerization may be conducted using a curing agent and/or heat. The precursor mixture is typically allowed to cure for sufficient time to form a matrix of carbon polymers and dispersed catalytic metal atoms or particles. In addition, the crystallizing dispersant may form a crystalline phase during the polymerizing step.

For hydrothermally polymerizable carbon precursors, polymerization typically occurs at elevated temperatures. In a preferred embodiment, the carbon precursor is heated to a temperature of about 0° C. to about 200° C., and more preferably between about 25° C. to about 120° C.

An example of a suitable condition for polymerization of resorcinol-formaldehyde gel (e.g., with iron particles and a solution pH of 1-14) is a solution temperature between 0° C. and 90° C. and a cure time of less than 1 hour to about 72 hours. Those skilled in the art can readily determine the conditions necessary to cure other carbon precursors under the same or different parameters.

The polymerization may be carried out by adding ammonia to adjust the pH, which increase the rate of polymerization by increasing the amount of cross linking that occurs between precursor molecules.

In one embodiment, polymerization is not allowed to continue to completion. Terminating the curing process before the entire solution is polymerized can help to form a plurality of intermediate nanostructures that will result in individual nanostructures, rather than a single mass of carbonized material. However, the present invention includes embodiments where the carbon precursor forms a plurality of intermediate carbon nanostructures that are linked or partially linked to one another. In this embodiment, individual nanostructures are formed during carbonization and/or during the removal of amorphous carbon.

In some embodiments, the catalytic metal may form particles and the carbon precursor may polymerize around the templating nanoparticles. However, in other embodiments, the catalytic metals may be merely dispersed in the carbon precursor material.

Forming intermediate carbon nanostructures from the dispersion of templating nanoparticles causes formation of a plurality of intermediate carbon nanostructures having unique shapes and sizes. Ultimately, the properties of the nanostructure can depend at least in part on the shape and size of the intermediate carbon nanostructure. Because of the unique shapes and sizes of the intermediate carbon nanostructures, the final nanostructures can have beneficial properties such as high surface area and high porosity, among others.

C. Carbonizing the Precursor Mixture

The precursor mixture is carbonized by heating to form an intermediate carbon material that includes a plurality of carbon nanostructures, amorphous carbon, and catalyst metal. The precursor mixture can be carbonized by heating the mixture to a temperature between about 500° C. and about 2500° C. During the heating process, atoms such as oxygen and nitrogen are volatilized or otherwise removed from the intermediate nanostructures (or the carbon around the templating nanoparticles) and the carbon atoms are rearranged or coalesced to form a carbon-based structure.

The carbonizing step typically produces a graphite based nanostructure. The graphite based nanostructure has carbon atoms arranged in structured sheets of sp² hybridized carbon atoms. The graphitic layers can provide unique and beneficial properties, such as electrical conduction and structural strength and/or rigidity.

D. Purifying the Intermediate Carbon Material

The intermediate or “carbonized” carbon material is purified by removing at least a portion of non-graphitic amorphous carbon. This purification step increases the weight percent of carbon nanostructures in the intermediate carbon material.

The amorphous carbon is typically removed by oxidizing the carbon. The oxidizing agents used to remove the amorphous carbon are selective to oxidation of the bonds found in non-graphitic amorphous carbon but are less reactive to the pi bonds of the graphitic carbon nanostructures. The amorphous carbon can be removed by applying the oxidative agents or mixtures in one or more successive purification steps.

Optionally substantially all or a portion of the catalytic metals can be removed. Whether the catalytic metal is removed and the extent to which it is removed will depend on the desired use of the carbon nanomaterial. In some embodiments of the invention, the presence of a metal such as iron can be advantageous for providing certain electrical properties and/or magnetic properties. Alternatively, it may be desirable to remove the catalytic metal to prevent the catalytic metal for having an adverse affect on its ultimate use. For example, it can be advantageous to remove the metal if the carbon nanostructures are to be used as a catalyst support material for a fuel cell. Removing the catalytic templating particles can also improve the porosity and/or lower its density.

Typically, the catalytic metals and/or templating nanoparticles are removed using acids or bases such as nitric acid, hydrogen fluoride, or sodium hydroxide. The method of removing the catalytic metals or amorphous carbon depends on the type of catalyst atoms in the composite. Catalyst atoms or particles (e.g., iron particles or atoms) can typically be removed by refluxing the composite nanostructures in 5.0 M nitric acid solution for about 3-6 hours.

Any removal process can be used to remove the catalytic metals and/or amorphous carbon so long as the removal process does not completely destroy the carbon nanostructures. In some cases it may even be beneficial to at least partially remove some of the carbonaceous material from the intermediate nanostructure during the purification process.

Optionally, the purification process can also include additional heat treatment steps at temperatures and conditions that can convert residual amorphous carbon to graphite. In this optional step, residual carbon is more easily converted to a graphitic material since a substantial portion of the amorphous carbon has been removed and there is better heat transfer to the portion that remains.

### IV. Carbon Nanostructures and Composite Materials

The methods of the present invention produce a carbon nanomaterial having multi-walled carbon nanostructures. The carbon nanostructures within the carbon nanomaterial have useful properties such as unique shape, size, and/or electrical properties. Reduced agglomeration of the carbon nanostructures is believed to be responsible for at least some of the beneficial and novel properties of the carbon nanomaterials of the invention.

The carbon nanostructures of the invention are particularly advantageous for some applications where high porosity, high surface area, and/or a high degree of graphitization are desired. Carbon nanostructures manufactured as set forth herein can be substituted for carbon nanotubes, which are typically more expensive to manufacture.

The carbon nanostructures can be regular or irregularly shaped spheroidal structures. In one embodiment, the carbon nanospheres have an irregular surface with graphitic defects that cause the nanospheres to have a shape that is not perfectly spherical. The inner diameter of the carbon nanostructures (i.e., the hollow center surrounded by a graphitic wall) can be between 0.5 nm to about 90 nm, more preferably between about 1 nm and about 50 nm.

The carbon nanomaterials of the invention can be characterized by their weight percent of carbon nanostructures. The weight percent of carbon nanostructures (e.g., nanospheres) in the carbon nanomaterial can be greater than 10%, preferably greater than 50%, and more preferably greater than 75%, and most preferably greater than 90%.

In many of the carbon nanostructures observed in TEM images, the outer diameter of the nanostructure is between about 10 nm and about 60 nm and the hollow center diameter is about 10 nm to about 40 nm. However, the present invention includes nanostructures having larger and smaller diameters. Typically, the carbon nanostructures have an outer diameter that is less than about 100 nm to maintain structural integrity.

The thickness of the nanostructure wall is measured from the inside diameter of the wall to the outside diameter of the wall. The thickness of the nanostructure can be varied during manufacture by limiting the extent of polymerization and/or carbonization of the carbon precursor as described above. Typically, the thickness of the carbon nanostructure wall is between about 1 nm and about 20 nm. However, thicker and thinner walls can be made if desired (e.g., less than about 15 nm, 10 nm, or 5 nm). The advantage of making a thicker wall is greater structural integrity. The advantage of making a thinner wall is greater surface area and porosity.

The wall of the carbon nanostructure can also be formed from multiple graphitic layers. In an exemplary embodiment, the carbon nanostructures have walls of between about 2 and about 100 graphite layers, preferably between about 5 and 50 graphite layers and preferably between about 5 and 20 graphite layers. The number of graphitic layers can be varied by varying the thickness of the carbon nanostructure wall as discussed above. The graphitic characteristic of the carbon nanostructures is believed to give the carbon nanostructures beneficial properties that are similar to the benefits of multi-walled carbon nanotubes (e.g., excellent conductivity). They can be substituted for carbon nanotubes and used in many applications where carbon nanotubes can be used but often with predictably superior results.

While the TEM images show nanostructures that are generally spherical, the present invention extends to nanostructures having shapes other than spheriodal. In addition, the nanostructures may be fragments of what were originally spheriodal shaped nanostructures.

In some embodiments, a majority of the carbon nanospheres by weight form agglomerates of less than 100 nanospheres, preferably less than 50 nanospheres, and more preferably less than 25 nanospheres. In some embodiments, a majority of the carbon nanospheres form agglomerates with a diameter of less than about 200 nm, preferably less than 100 nm, and more preferably less than 50 nm. As discussed more fully below with regard to Example 1 and as shown in the Figures, carbon nanospheres manufactured according to the methods described herein can exhibit substantially less agglomeration than carbon nanospheres manufactured using similar methods without the use of a crystallizing dispersant.

In addition to good electron transfer, the carbon nanostructures of the present invention can have high porosity and large surface areas. Adsorption and desorption isotherms indicate that the carbon nanostructures form a mesoporous material. The BET specific surface area of the carbon nanostructures can be between about 80 and about 400 m²/g and is preferably greater than about 120 m²/g (e.g., between about 120 m²/g and about 300 m²/g), and typically about 200 m²/g, which is significantly higher than the typical 100 m²/g observed for carbon nanotubes. Even where the methods of the invention results in carbon nanostructures combined with non-structured graphite, this graphitic mixture (i.e., the carbon nanomaterial) typically has a surface area greater than carbon nanotubes. The high surface area and high porosity of the carbon nanostructures manufactured according to the present invention makes the carbon nanostructures useful for a variety of applications.

In one embodiment, the carbon nanomaterials are dispersable in a hydrophilic material, such as an aqueous solution. Examples of polar solvents that the carbon nanospheres can be dispersed in include, but are not limited to, water, alcohols (e.g., methanol and/or ethanol), THF, DMF, acetic acid, formic acid, trifluoroacetic acid, formamide, acetonitrile, NH₂—NH₂. One advantage of dispersing the carbon nanospheres in a polar solvent is that the carbon nanospheres can be more readily combined with some polymeric materials to form a composite.

The carbon nanospheres may also be combined with organic solvents including non-polar organic solvents. Examples of non-polar solvents include methylpyrrolidone (NMP), pyridine, 1-(3 aminopropyl)imidazoles, 1-Diethoxy methyl imidazoles, 1-2(hydroxyethyl)imidazoles, 4(1H-imidazole-1-yl)aniline, 4(imidazole 1-yl)phenol, barbituric acid, 1-methyl 2-pyrrolidinone hydrazone hydrochloride, quinoxaline, 1-ethyl-4-piperidone, 1-ethylpiperazine, ethyl 2-picolinate, or a combination thereof.

In one embodiment of the invention, the carbon nanospheres may be incorporated into a polymeric material to form a composite. The polymeric material used to make the composite can be any polymer or polymerizable material compatible with graphitic materials. Example polymers include polyamines, polyacrylates, polybutadienes, polybutylenes, polyethylenes, polyethylenechlorinates, ethylene vinyl alcohols, fluoropolymers, ionomers, polymethylpentenes, polypropylenes, polystyrenes, polyvinylchlorides, polyvinylidene chlorides, polycondensates, polyamides, polyamide-imides, polyaryletherketones, polycarbonates, polyketones, polyesters, polyetheretherketones, polyetherimides, polyethersulfones, polyimides, polyphenylene oxides, polyphenylene sulfides, polyphthalamides, polythalimides, polysulfones, polyarylsulfones, allyl resins, melamine resins, phenol-formaldehyde resins, liquid crystal polymers, polyolefins, silicones, polyurethanes, epoxies, polyurethanes, cellulosic polymers, combinations of these, derivatives of these, or copolymers of any of the foregoing. The polymerizable materials can be a polymer or a polymerizable material such as a monomer, oligomer, or other polymerizable resin.

The carbon nanospheres may be mixed with the polymeric material in a range of about 0.1% to about 70% by weight of the composite, more preferably in a range of about 0.5% to about 50% by weight, and most preferably in a range of about 1.0% to about 30%. The carbon nanospheres can be added alone or in combination with other graphitic materials to give the composite conductive properties. To impart electrical conductivity, it is preferable to add more than about 3% by weight of carbon nanospheres in the composite, more preferably greater than about 10% by weight, and most preferably greater than about 15%.

As a method for producing the composite of the present invention, any known method can be used. For example, pellets or powder of the polymeric material and a desired amount of the carbon nanospheres can be dry-blended or wet-blended and then mixed in a roll kneader while heated, or fed in an extrusion machine to extrude as a rope and then cut into pellets. Alternatively, the carbon nanospheres can be blended in a liquid medium with a solution or dispersion of the resin. When a thermosetting polymerizable material is used, the carbon nanospheres can be mixed with a monomer or oligomer using any known method suitable for the particular resin.

### V. Example

The following example provides a formula for making carbon nanomaterials containing carbon nanostructures according to the present invention.

### Example 1

Example 1 describes the preparation of an intermediate carbon nanomaterial having carbon nanospheres.

(a) Preparation of Precursor Solution

81.08 g of FeCl₃.6H₂O was dissolved in 1.0 L of Di-water and added to a 5.0 L flask. To this flask was added 181.68 g of Resorcinol, 297.26 g of D-glucose and an additional 2.0 L of Di-water. The solution was stirred until resorcinol was fully dissolved. Then 267 g of Formaldehyde was added to the above solution and stirred for 5˜10 minutes

(b) Polymerization

290 ml of Ammonium hydroxide was added drop-wise to the precursor solution with vigorous stirring and cured at 8090° C. for 5 hours to form a polymerized carbon material. The solid polymerized material was collected by filtration and dried in an oven.

(c) Carbonization

The polymerized carbon material was placed in crucibles and covered with a crucible plate and transferred to a furnace for carbonization. The carbonization process was conducted under ample amount of nitrogen flow and carried out under the temperature program as follows: heating to 1050° C. at 20° C./min, holding at 1050° C. for 5 hrs, and cooling to room temperature.

(d) Purification

The carbonized carbon product was refluxed in 5M HNO₃ for 6 hours followed by treating in 4M HCl at 90° C. for 6 hrs. The purified carbon nanomaterial was washed with ample amounts of water until the pH reached ˜5. The purified carbon nanomaterial was then collected and dried in an oven overnight at 80° C.

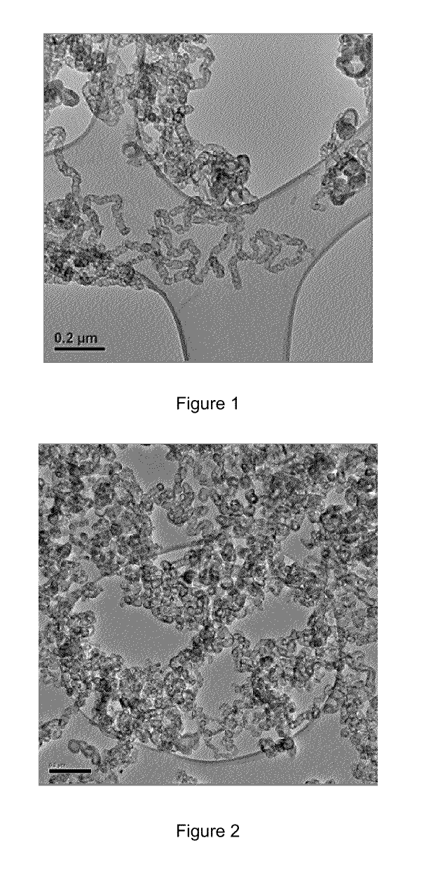

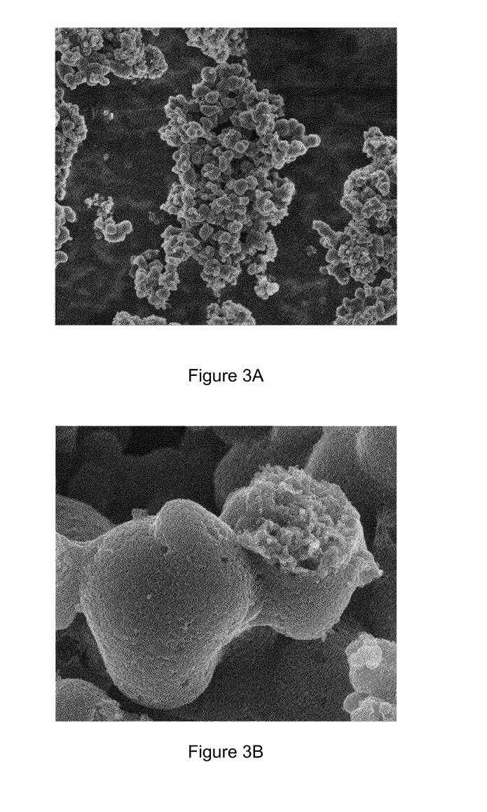

FIGS. 1 and 2 illustrate TEM images taken of two different samples of the carbon nanomaterial manufactured according to Example 1. FIGS. 3A and 3B are comparative examples showing TEM images of carbon nanospheres manufactured without a crystallizing dispersant. As can be seen in the TEM images, the dispersed carbon nanomaterials of FIGS. 1 and 2 exhibits minimal agglomeration.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for manufacturing a carbon nanomaterial, comprising,
forming a precursor mixture comprising a carbon precursor, a catalytic metal, and a crystallizing dispersant;
polymerizing the carbon precursor to form a polymerized carbon material having a crystalline phase therein, the crystalline phase derived from the crystalline dispersant;
carbonizing the cured carbon material to form an intermediate carbon material comprising a plurality of carbon nanostructures, amorphous carbon, and catalytic metal; and
purifying the intermediate carbon material by removing at least a portion of the amorphous carbon and at least a portion of the catalytic metal.

2. A method as in claim 1, wherein the crystallizing dispersant is included in the precursor mixture in a molar ratio of about 0.25:1 to about 1:0.25 of crystalline dispersant to carbon precursor.

3. A method as in claim 1, wherein the crystallizing dispersant is included in the precursor mixture in a molar ratio of about 0.5:1 to about 1:0.5 of crystalline dispersant to carbon precursor.

4. A method as in claim 1, wherein the crystallizing dispersant includes a carbohydrate.

5. A method as in claim 4, wherein the carbohydrate comprises a monosaccharide.

6. A method as in claim 4, wherein the carbohydrate is selected from the group consisting of allose, altrose, glucose, gulose, idose, talose, psicose, fructose, sorbose, tagatose, ribose, arabinose, xylose, lyxose, ribulose, xylulose, derivatives thereof, and combinations thereof.

7. A method as in claim 1 wherein the carbon precursor comprises a member selected from the group consisting of resorcinol, phenol resin, melamine-formaldehyde gel, poly(furfuryl alcohol), poly(acrylonitrile), and petroleum pitch.

8. A method as in claim 1, wherein the precursor mixture has a pH of at least about 4.0.

9. A method as in claim 1, wherein the precursor mixture has a pH greater than about 5.0.

10. A carbon nanomaterial manufactured according to the method of claim 1.

11. A composite material comprising the carbon nanomaterial of claim 10.

12. A method for manufacturing a carbon nanomaterial, comprising,
forming a precursor mixture comprising a carbon precursor, a catalytic metal salt, and a carbohydrate, wherein the carbohydrate is not ionized;
polymerizing the carbon precursor to form a polymerized carbon material comprising a crystalline phase derived from the carbohydrate;
carbonizing the cured carbon material to form an intermediate carbon material comprising a plurality of carbon nanostructures, amorphous carbon, and catalytic metal; and
purifying the intermediate carbon material by removing at least a portion of the amorphous carbon and at least a portion of the catalytic metal.

13. A method as in claim 12, wherein the crystalline dispersant is included in the precursor mixture in a molar ratio of about 0.25:1 to about 1:0.25 of crystalline dispersant to carbon precursor.

14. A method as in claim 12, wherein the carbohydrate comprises a monosaccharide.

15. A method as in claim 14, wherein the carbohydrate is selected from the group consisting of allose, altrose, glucose, gulose, idose, talose, psicose, fructose, sorbose, tagatose, ribose, arabinose, xylose, lyxose, ribulose, xylulose, derivatives thereof, and combinations thereof.

16. A method as in claim 12 wherein the carbon precursor comprises a member selected from the group consisting of resorcinol, phenol resin, melamine-formaldehyde gel, poly(furfuryl alcohol), poly(acrylonitrile), and petroleum pitch.

17. A method as in claim 12, wherein the precursor mixture has a pH of at least about 4.0.

18. A method as in claim 12, wherein the precursor mixture has a pH of at least about 5.0.

19. A carbon nanomaterial manufactured according to the method of claim 12.

20. A composite material comprising the carbon nanomaterial of claim 19.
